(19) United States
(12) Patent Application Publication
(10) Pub. No.: US 2016/0055413 A1
(43) Pub. Date: Feb. 25, 2016

(54) METHODS AND SYSTEMS THAT CLASSIFY AND STRUCTURE DOCUMENTS

(71) Applicant: ABBYY Development LLC, Moscow (RU)

(72) Inventors: Sergey Popov, Moscow (RU); Dmitry Deryagin, Moscow (RU)

(21) Appl. No.: 14/571,864

(22) Filed: Dec. 16, 2014

(30) Foreign Application Priority Data
Aug. 21, 2014 (RU) 2014134291

(51) Int. Cl. G06N 5/04; G06F 17/30

(52) U.S. Cl. CPC G06N 5/04; G06F 17/30011

(57) ABSTRACT

The current document is directed to methods and systems that classify electronic documents. In one implementation, multiple hypotheses for the type and structure of the document are automatically generated or identified. A page hypothesis is selected for each page of the document, using one or more page hypotheses already selected for one or more neighboring pages when such already selected page hypotheses are available. The selected page hypotheses are then used to automatically select one of the multiple document hypotheses and a corresponding document type, following which various document-processing and document-refinement operations can be applied to the document according to the selected document hypothesis and document type.

### CROSS REFERENCE TO RELATED APPLICATIONS

This application claims the benefit of priority to Russian Patent Application No. 2014134291, filed Aug. 21, 2014; disclosure of which is incorporated herein by reference in its entirety.

### TECHNICAL FIELD

The current application is directed to automated document analysis using context-based page-hypothesis evaluation.

### BACKGROUND

Printed, typewritten, and handwritten documents have long been used for recording and storing information. Despite current trends towards paperless offices, printed documents continue to be widely used in commercial, institutional, and home environments. With the development of modern computer systems, the creation, storage, retrieval, and transmission of electronic documents has evolved, in parallel with continued use of printed documents, into an extremely efficient and cost-effective alternative information-recording and information-storage medium. Because of overwhelming advantages in efficiency and cost effectiveness enjoyed by modern electronic-document-based information storage and information transactions, printed documents are routinely converted into electronic documents by various methods and systems, including conversion of printed documents into digital scanned-document images using electro-optico-mechanical scanning devices, digital cameras, and other devices and systems followed by automated processing of the scanned-document images to produce electronic documents encoded according to one or more of various different electronic-document-encoding standards. As one example, it is now possible to employ a desktop scanner and sophisticated optical-character-recognition (“OCR”) programs running on a personal computer to convert a printed-paper document into a corresponding electronic document that can be displayed and edited using a word-processing program.

While modern OCR programs have advanced to the point that complex printed documents that include pictures, frames, line boundaries, and other non-text elements as well as text symbols of any of many common alphabet-based languages can be automatically converted to electronic documents, challenges remain with respect to accurate automatic classification of documents, whether produced from OCR processing or acquired from various sources of unclassified electronic documents, including documents harvested from Internet searches and other online document sources. Accurate classification of a document provides a basis for many types of refinement and processing of the document based on the document type.

### SUMMARY

The current document is directed to methods and systems that classify electronic documents. In one implementation, multiple hypotheses for the type and structure of the document are automatically generated or identified. A page hypothesis is selected for each page of the document, using one or more page hypotheses already selected for one or more neighboring pages when such already selected page hypotheses are available. The selected page hypotheses are then used to automatically select one of the multiple document hypotheses and a corresponding document type, following which various document-processing and document-refinement operations can be applied to the document according to the selected document hypothesis and document type.

### BRIEF DESCRIPTION OF THE DRAWINGS

FIG. 1 provides a general architectural diagram for various types of computers and other processor-controlled devices.

FIG. 2 illustrates the logical structure of information contained in a scanned image of one or more documents.

FIG. 3 illustrates multiple hypotheses at multiple levels of a logical document structure.

FIG. 4 illustrates an example of page hypotheses generated from primitive page objects.

FIGS. 5-9 illustrate one approach to classifying an electronic document.

FIGS. 10-11 provide control-flow diagrams to illustrate the process of analyzing a document to classify the document and, in certain cases, perform various post-classification processing tasks.

FIGS. 12A-D illustrate deficiencies in the document-processing methods discussed above with reference to FIGS. 2-11.

FIGS. 13A-E illustrate a context-based approach, using illustration conventions previously used in FIG. 7, that ameliorate the deficiencies discussed above with reference to FIGS. 12A-D.

FIGS. 14A-C illustrate the nature of document and page hypotheses and page-related data structures.

FIG. 15 provides a control-flow diagram for a routine that generates a weight for the comparison of a page object with one or more page hypotheses.

### DETAILED DESCRIPTION

The current document is directed to methods and systems that classify and structure electronic documents. In one implementation, one of multiple hypotheses for the type and structure of the document is selected using page hypotheses selected for each page of the document. A hypothesis is selected from among multiple hypotheses for a page using one or more page hypotheses already selected for one or more neighboring pages, when such already selected page hypotheses are available. The document hypothesis is then used as a basis for classifying the document (or for determination of document's logical structure) and for various types of automated document processing, including refinement of the document formatting and structure based on the classification provided by hypothesis selection.

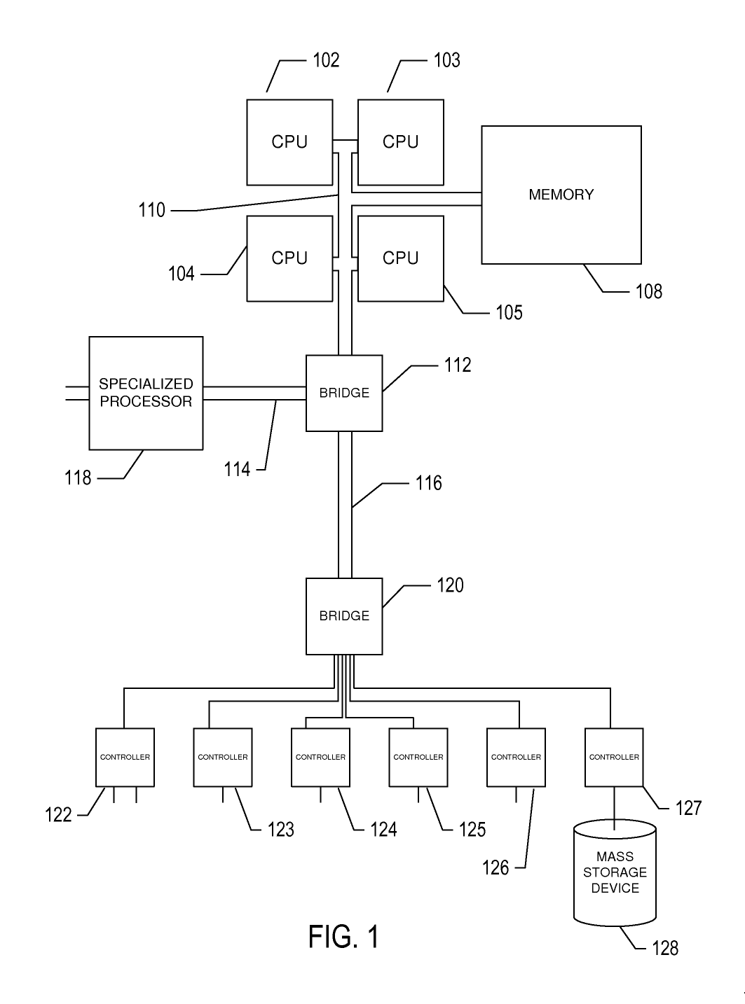

FIG. 1 provides a general architectural diagram for various types of computers and other processor-controlled devices. The high-level architectural diagram may describe a modern computer system, including a computer system that is programmed to carry out automated document classification according to the methods discussed below. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources.

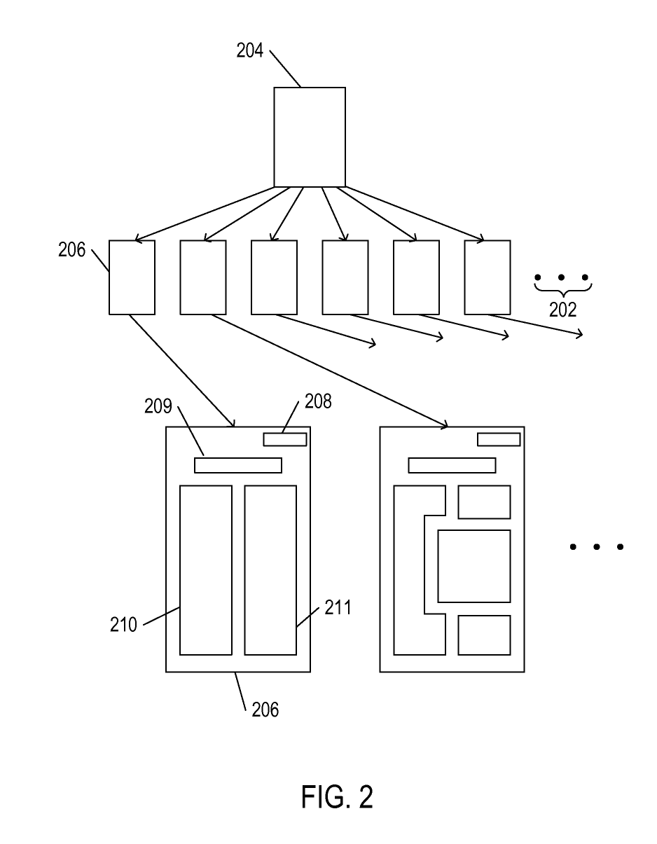

FIG. 2 illustrates the logical structure of information contained in a generalized electronic document. In FIG. 2 and in subsequent figures, ellipses, such as ellipsis 202, are used to indicate the possibility of additional nodes in a hierarchical structure at a given level. An electronic document 204 generally consists of one or more pages, such as page 206. Each page can be further decomposed into logical page objects, such as logical page objects 208-211 within page 206. Thus, an electronic document 204 can be logically decomposed into hierarchically organized components, from pages all the way down to objects within pages, such as a left-hand text column 210 within page 206. Many logical page objects can themselves be further hierarchically decomposed, including decomposition of text-containing logical page objects into text lines, words, and symbols.

During the process of classifying a document, each logical subcomponent of the document is generally identified and characterized. Characterization may include establishing numerical and other values for a large number of parameters, including: (1) parameters that specify the shape, size, and location of the logical component within the scanned image and within containing, higher-level logical subcomponents; (2) parameters that specify the type of the subcomponent, such as text object, image, title, header, footnote, and other such subcomponent types; (3) parameters that specify the font size of text within text-containing objects; and (4) additional parameters that specify additional features and characteristics of logical entities within an electronic document. This information can be used, as one example, to refine the encoding of an initial version of an electronic document so that, when the electronic document is recognized and exported by an OCR application, the encoded document (machine-readable and machine-editable document) appears as closely as possible to an original scanned document image from which the initial version of the electronic document was produced by a document analysis system. However, during the identification and characterization of logical entities, there may be many different possible higher-level interpretations of the logical entities. These different interpretations are referred to as “hypotheses.”

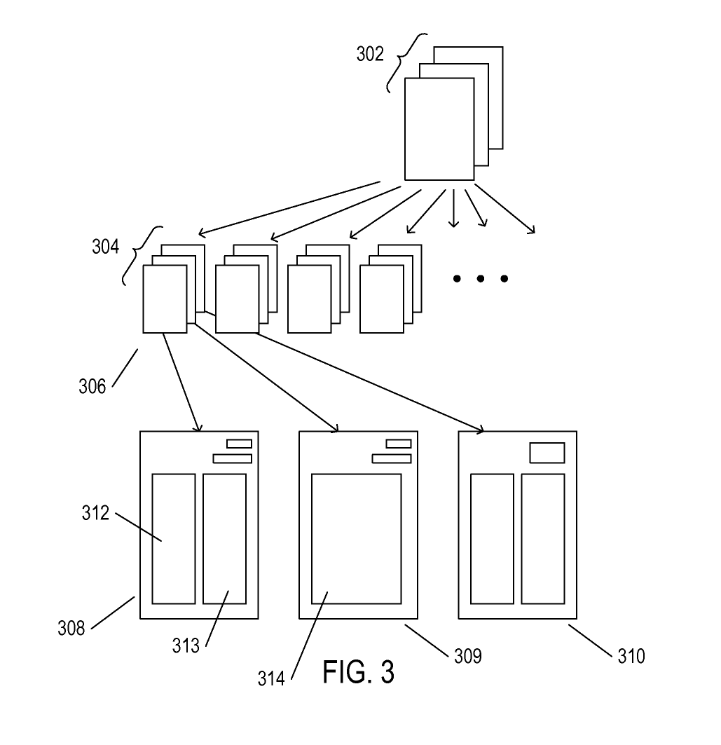

FIG. 3 illustrates multiple hypotheses at multiple levels of a logical document structure. As shown in FIG. 3, during characterization of the logical components of a document, there may be, at a given point in time, multiple different possible interpretations, or hypotheses, for the structure of the document as a whole 302 and multiple different hypotheses for the structure of each page of the document, such as the set of three hypotheses 304 shown for a first page 306 within the document. The three hypotheses are shown in greater detail as page hypotheses 308-310. Hypothesis 308, for example, includes two text columns 312 and 313 while hypothesis 309 includes a single wide text column 314.

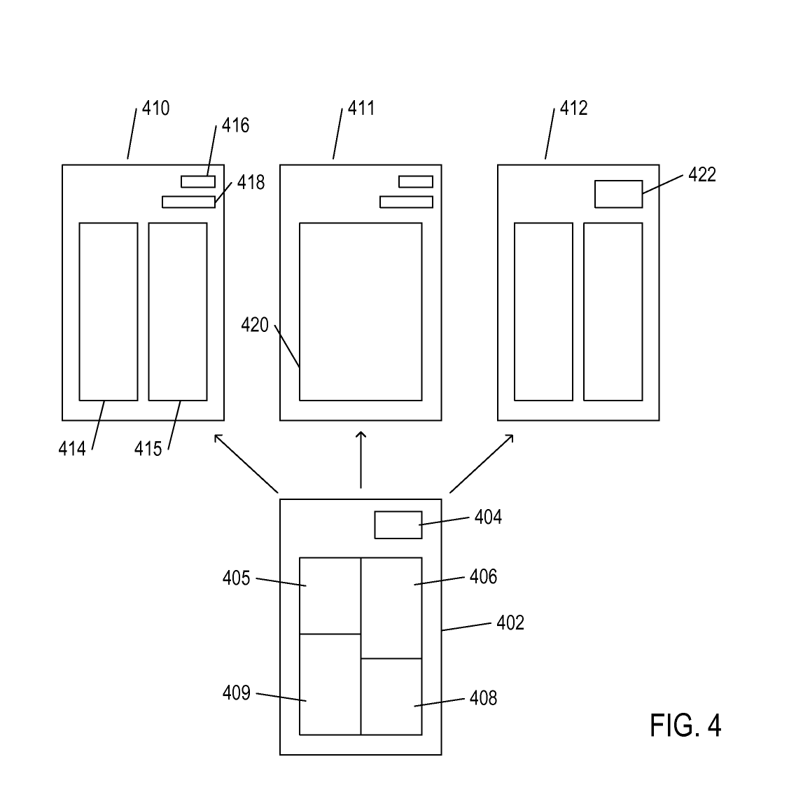

In one approach to determining the structure of a page, the page is processed in order to identify different logical page objects within the page based on primitive objects identified within the page. FIG. 4 illustrates an example of page hypotheses generated from primitive page objects. Processing is initially carried out on a page to identify various different primitive objects within the page, such as vertical and horizontal black separators, vertical and horizontal dotted separators, vertical and horizontal gradient separators, inverted zones, word fragments, and white separators. The various primitive objects are then used, in turn, along with various different types of features and metrics to identify and characterize distinct portions of the page 404-408. Then, as shown in FIG. 4, a number of different page hypotheses 410-412 can be generated by selecting corresponding page models, from a collection of page models, compatible with the identified and characterized distinct portions of the document 404-408. For example, in FIG. 4, the portions 404-408 in the page 402 may be compatible with a page that includes two columns of text 414-15, a page number 416, and a right justified header 418, but also may be compatible with a similar, single-column 420 page or with a two-column page having a small image or table 422 rather than the page number and right justified header. The text columns, headers, and other components of a page model are referred to as “logical page objects.” The distinct portions of the page are referred to, in this document, as “page objects.”

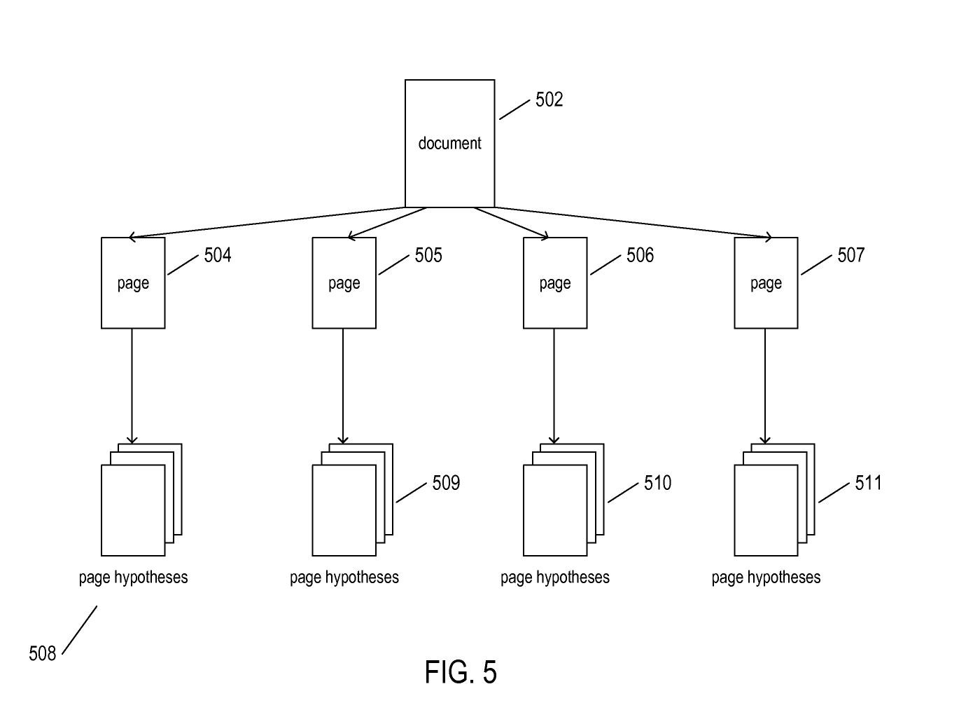

FIGS. 5-9 illustrate one approach to classifying an electronic document. As shown in FIG. 5, the electronic document 502 generally contains a sequence of pages 504-507. Each of the pages is processed to identify page objects within the page. A set of page hypotheses 508-511 is determined for each page with identified page objects. In FIG. 5, four sets of page hypotheses 508-511 are shown as having been determined for pages 504-507. Although three page hypotheses are shown for each page, in FIG. 5, any number of page hypotheses from one to some relatively large number may be determined. In FIG. 5, and in subsequent figures, the number of hypotheses in a set of hypotheses shown in a figure does not indicate the actual number of hypotheses that may have been determined for the example, but only that there may be multiple hypotheses.

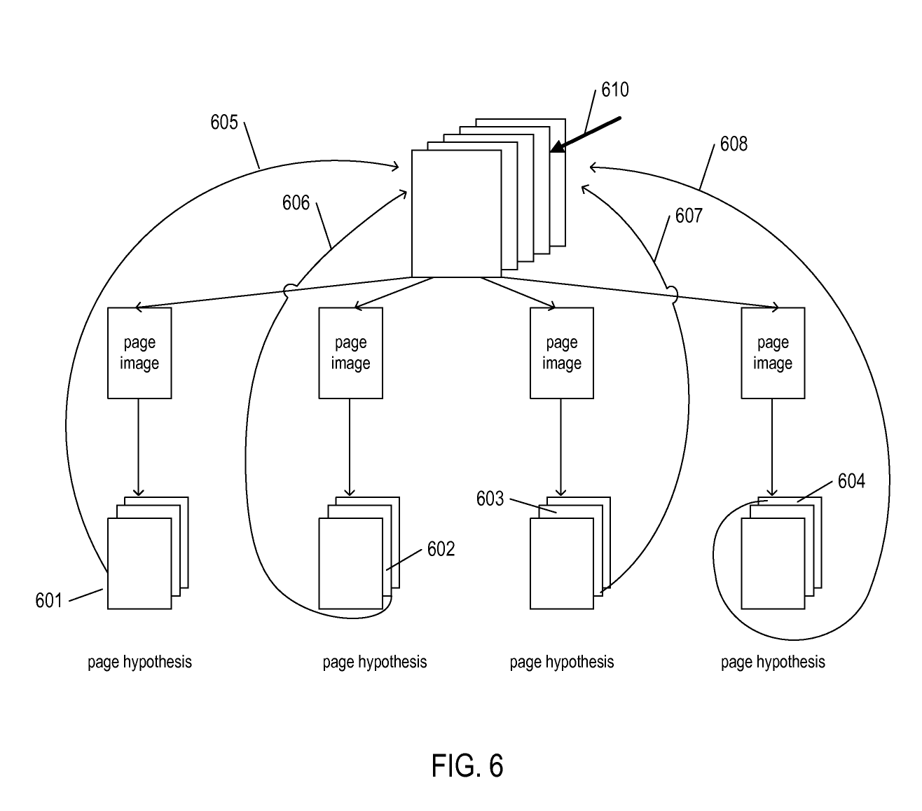

As shown in FIG. 6, a best page hypothesis is selected for each page, as represented by curved arrows 601-604, and the selected page hypotheses are used, as represented by curved arrows 605-608, to select one document hypothesis from a set of document hypotheses that best describes the entire electronic document. The document-hypothesis selection is represented by solid arrow 610 in FIG. 6.

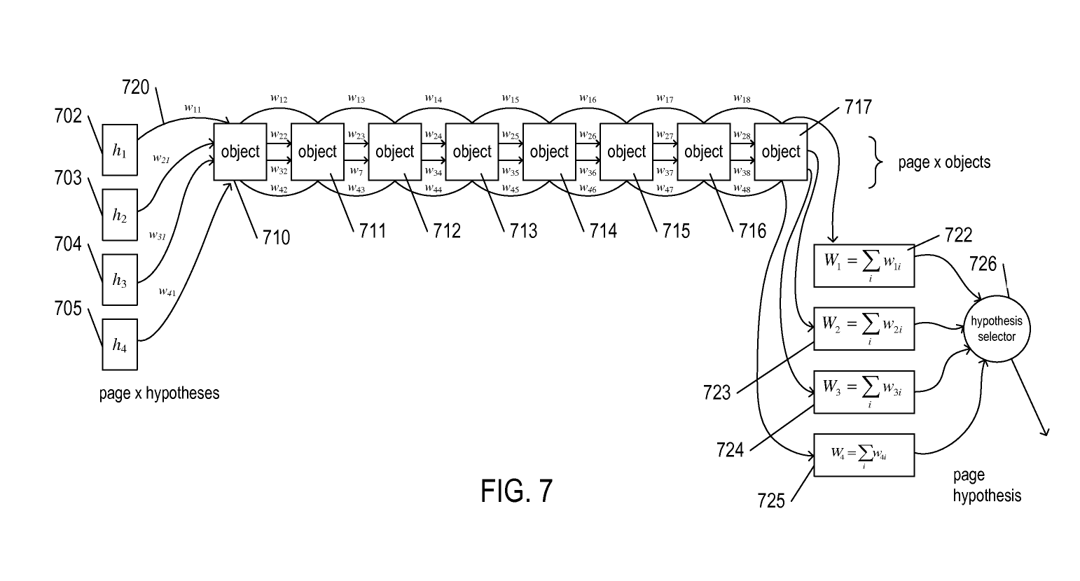

FIG. 7 shows one approach to selecting a best page hypothesis for a page. First, a set of possible page hypotheses 702-705 is determined. There are numerous ways to make this determination. In one approach, there may be a comprehensive set of possible page hypotheses based on a collection of page models that can be cursorily evaluated against one or more page objects in order to select a subset of the possible page hypotheses that may be relevant to the page. In other techniques, the page hypotheses can be generated on the basis of both the collection of models and the identified page objects within the page as a set of page hypotheses consistent with the identified page objects. Other approaches to determining a set of page hypotheses are possible. Then, a cumulative weight or figure of merit is computed for each hypothesis by logically traversing all of the page objects 710-717 identified within the page and accumulating individual weights or figures of merit computed for each object with respect to the page hypothesis. In this discussion, the higher the cumulative weight (the fine), the less likely that a hypothesis actually explains the page. Thus, the lower the computed cumulative weight (the fine) for a hypothesis, the more likely that the hypothesis is true. Of course, an opposite convention can be employed in alternative implementations. The traversal of the page objects 710-717 for the first hypothesis 702 is indicated by a series of curved arrows, beginning with curved arrow 720. As shown in rectangle 722, a total cumulative weight W₁ or figure of merit for the hypothesis is computed as a sum of the weights w₁ᵢ computed for each object with respect to the hypothesis. Similar weights are computed for the other three hypotheses 723-725. Then, a hypothesis selector 726 chooses the hypothesis associated with the smallest cumulative weight (with the smallest fine) as the best page hypothesis for the page. Computing the weight for a page object with respect to a page hypothesis can be done in many different ways, one of which is discussed below.

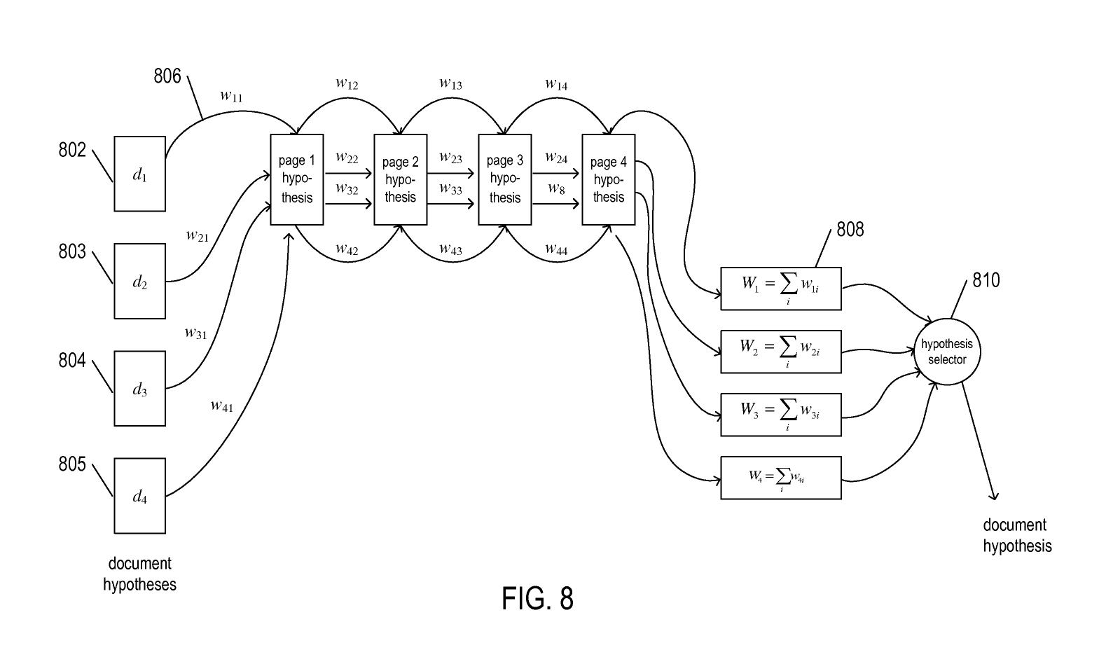

FIG. 8 illustrates, using illustration conventions similar to those used in FIG. 7, the selection of a document hypothesis based on the best page hypothesis determined for each page in the document image. First, a set of possible document hypotheses is generated or determined 802-805. The possible document hypotheses may be selected from a collection of document models, in similar fashion to the selection page hypotheses for a page. Then, a cumulative weight or score is computed for each document hypothesis based on the sum of weights computed by evaluating each page hypothesis selected for each page with respect to the document hypothesis. Thus, for the first document hypothesis 802, the page hypotheses for each page in the document image are traversed, as represented by a path of curved arrows, starting with curved arrow 806, to produce a weight for each page hypothesis w₁₁ with respect to the first document hypothesis 802. Individual weights w₁ᵢ are then summed to produce the cumulative weight for the document hypothesis W₁, as shown in box 808. A hypothesis selector 810 then selects, as the best document hypothesis, the document hypothesis with the smallest cumulative weight. In one approach, an initial set of all possible document hypotheses is filtered with respect to a few logical page objects to produce a subset of possible document hypotheses for the document. The filtering may consider one or a few logical page objects from one or a few pages within the document image based on the page hypotheses selected for the one or a few pages. The possible document hypotheses are then used to traverse the page hypotheses selected for the pages, as shown in FIG. 8, with the possible document hypothesis having the smallest cumulative weight then selected as the best document hypothesis. As with selecting page hypotheses for pages, discussed with reference to FIG. 7, the weight computed for a page-hypothesis/document-hypothesis pair represents a degree of compatibility of the logical page corresponding to the page hypothesis with the document hypothesis. For example, a page hypothesis that specified three narrow vertical text columns would not be compatible with a document hypothesis that specifies pages with single text columns that span the widths of the pages.

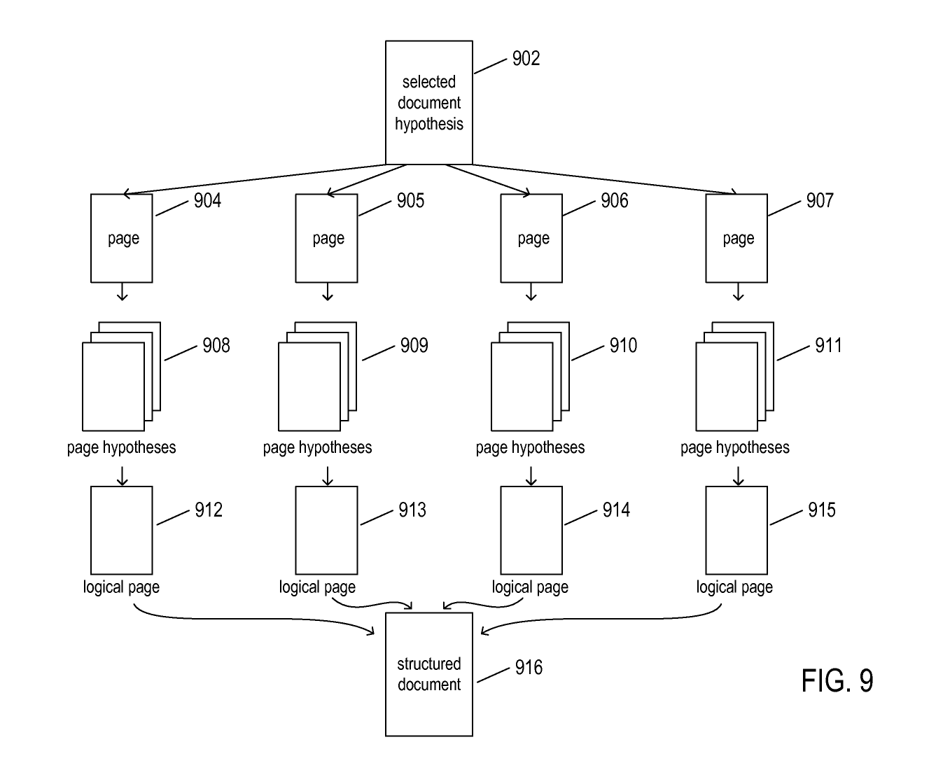

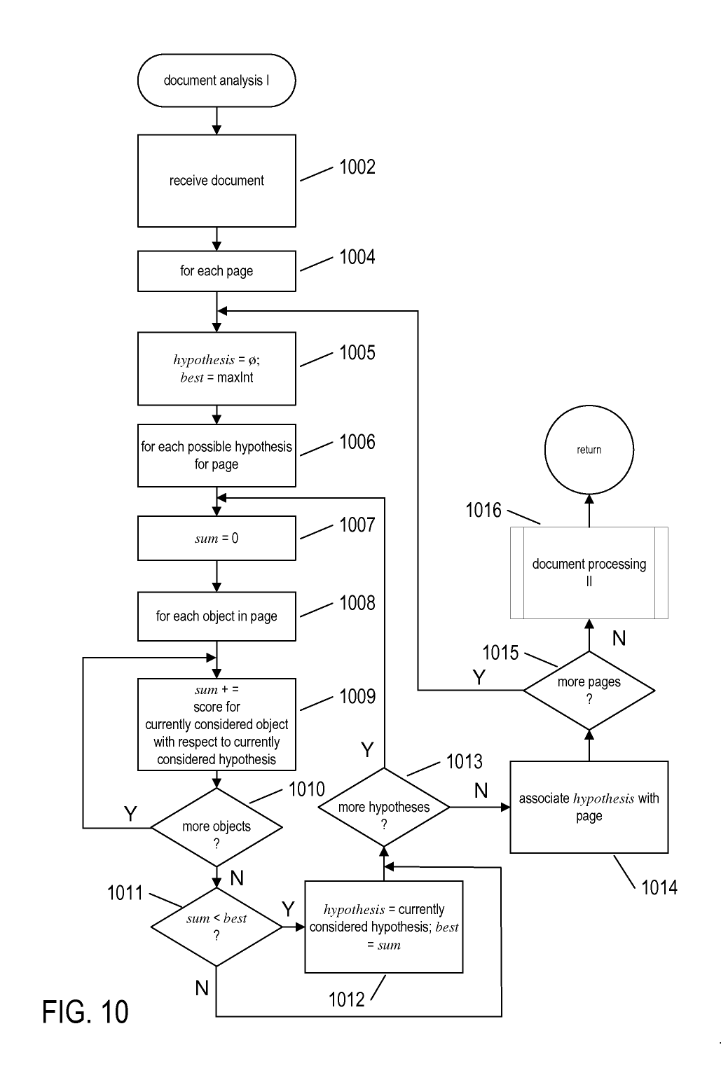

FIG. 9 illustrates automated processing steps that may occur following document classification. The selected document hypothesis 902, along with pages containing page objects 904-907, are used to again determine a number of page hypotheses for each page. In FIG. 9, the sets of page hypotheses 908-911 are identified for corresponding pages 904-907, respectively. A best page hypothesis is selected from each set of page hypotheses and is used, along with the page and page objects contained in the page, to determine the logical page objects within the page which together comprise a logical page corresponding to the page. In FIG. 9, logical pages 912-915 are produced from the best page hypotheses selected for the sets of page hypotheses 908-911. The logical pages are then used to refine the document encoding to produce a structured document 916. For example, the selected document hypothesis may specify certain formatting conventions that were not uniformly observed in the initial encoded document. After refinement, the structured document more comprehensively reflects the selected document hypothesis as a result of uniform formatting according to the formatting conventions specified by the selected document hypothesis. However, in certain cases, document analysis may terminate with classification of the document by selection of a document hypothesis and storing of an indication of the type of the document in memory or another physical data-storage device.

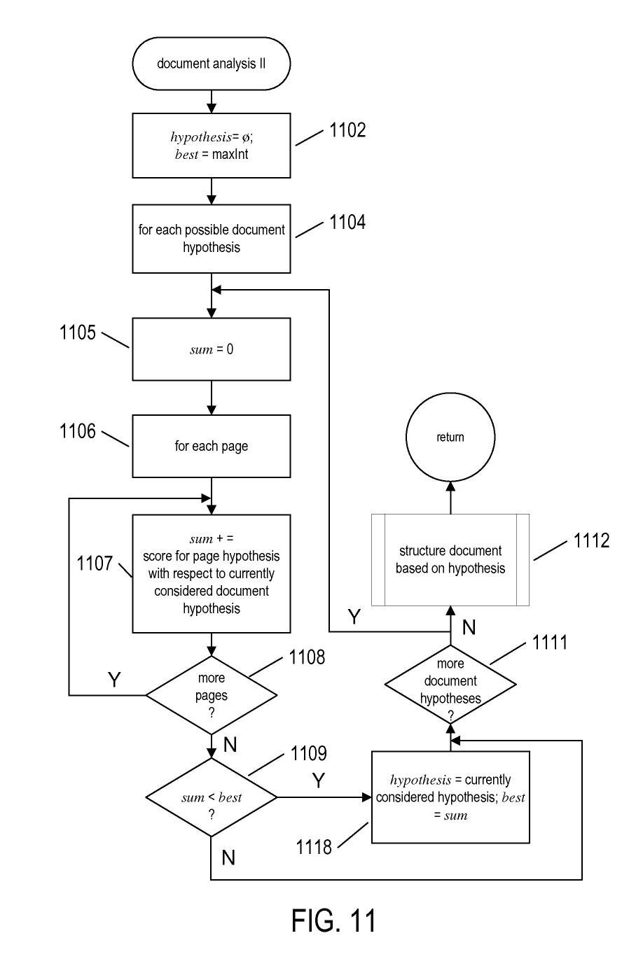

FIGS. 10-11 provide control-flow diagrams to illustrate the process of analyzing a document to classify the document and, in certain cases, perform various post-classification processing tasks. FIG. 10 provides a control-flow diagram for the routine “document processing I.” In step 1002, the routine “document processing I” receives an electronic document. Then, in the outer for-loop of three nested for-loops of steps 1004-1015, each page within the document image is considered. In step 1005, a local reference variable hypothesis is set to null and a local variable best is set to some very large number. Then, in the first inner for-loop of steps 1006-1013, each possible page hypothesis is evaluated. In step 1007, the local variable sum is set to 0. Then, in the second inner for-loop of steps 1008-1010, the cumulative weight for the page hypothesis is computed by considering each object in the page, computing a score for the currently considered object with respect to the currently considered hypothesis, and adding the computed score to the local variable sum, in step 1009. When the computed weight for the page hypothesis is less than value stored in the local variable best, as determined in step 1011, the local variable hypothesis is set to the currently considered hypothesis and a local variable best is set to the computed weight for the hypothesis, in step 1012. When there are more hypotheses to consider, as determined in step 1013, control returns to step 1007. In step 1014, the best determined hypothesis, referenced by the local variable hypothesis, is associated with the currently considered page. Note that, in the control-flow diagram provided in FIG. 10, it is assumed that at least one hypothesis produces a cumulative weight less than the large number “maxInt” and that a best hypothesis is therefore found. When there are more pages to consider in the outer for-loop of steps 1004-1015, as determined in step 1015, control returns to step 1005. Otherwise, the routine “document processing II” is called, in step 1016.

FIG. 11 provides a control-flow diagram for the routine “document processing II,” called in step 1016 of FIG. 10. In step 1102, the local variable hypothesis is set to null and the local variable best is set to a large number. Then, in the outer for-loop of steps 1104-1111, each possible document hypothesis is considered. In step 1105, the local variable sum is set to 0. Then, in the inner for-loop of steps 1106-1108, each page within the document image is considered. In step 1107, a weight or figure of merit is computed for the selected page hypothesis for the page with respect to the currently considered document hypothesis. The weights computed for each page hypothesis with respect to the currently considered document hypothesis are accumulated in the inner for-loop of steps 1106-1108 to produce a cumulative weight for the currently considered document hypothesis. When the value stored in the local variable sum is lower than the value stored in the local variable best, as determined in step 1109, the local variable hypothesis is set to reference the currently considered hypothesis and the local variable best is set to the contents of the local variable sum, in step 1116. When there are more document hypotheses to consider, as determined in step 1111, control returns to step 1105. Otherwise, the routine “document processing II” calls the routine “generate encoded document based on selected document hypothesis,” in step 1112, to carry out additional processing steps discussed with reference to FIG. 9, above. These steps may include storing a classification for the document in memory, a mass-storage device, or other physical storage device, refining the document encoding based on the classification, and many additional types of document processing for which a document classification is used.

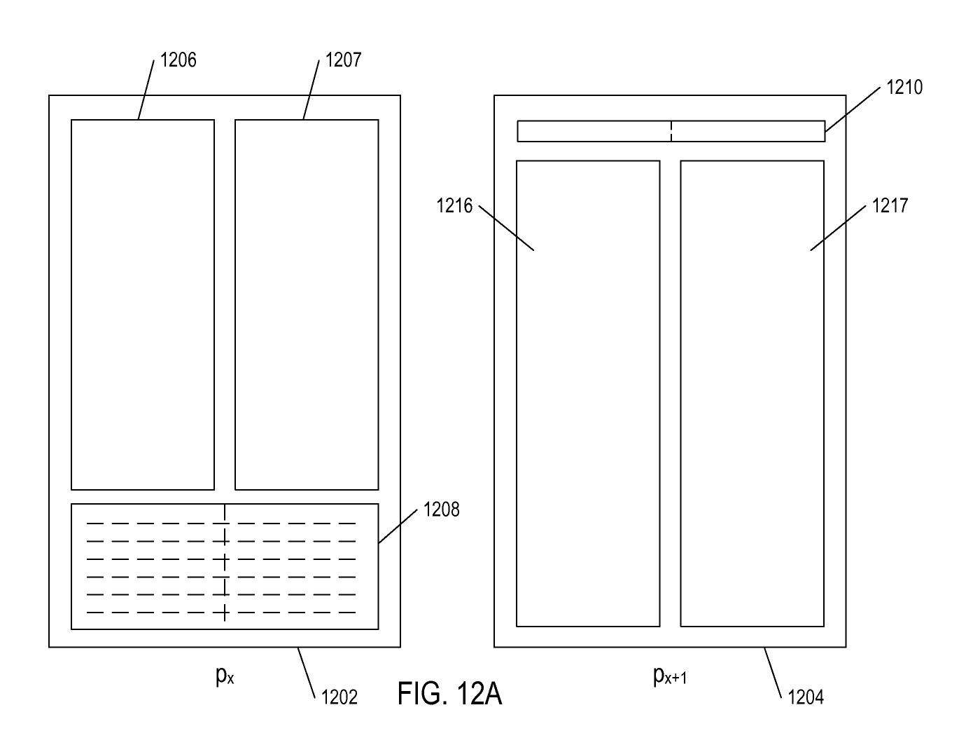

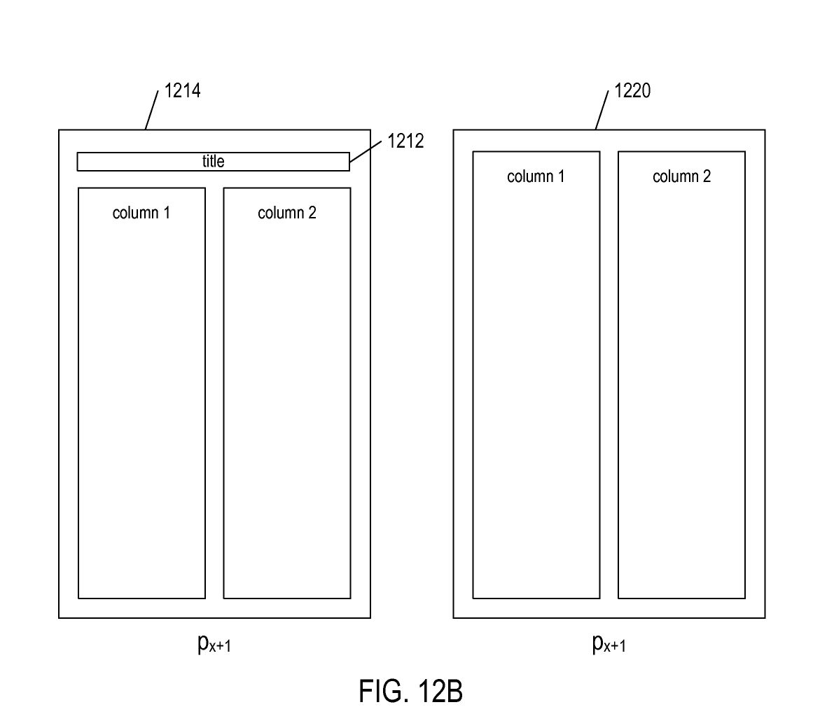

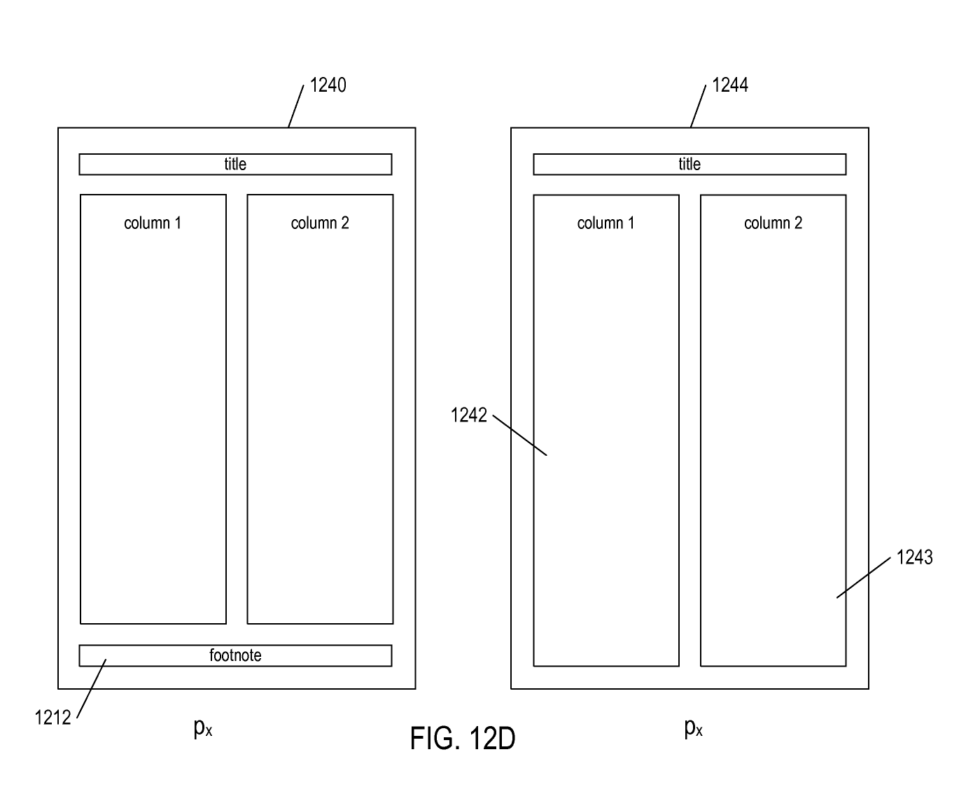

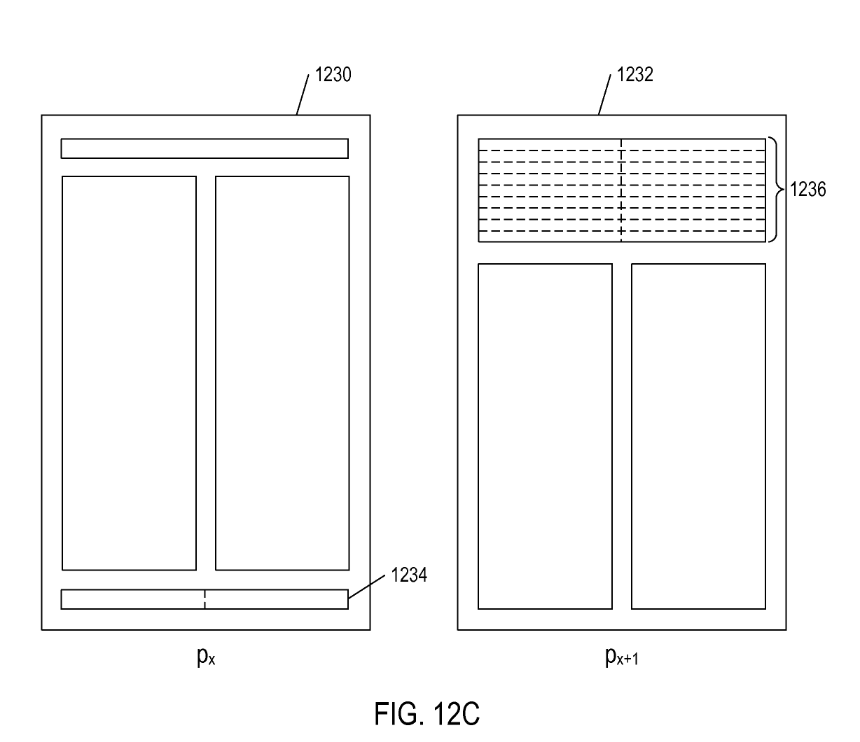

FIGS. 12A-D illustrate deficiencies in the document-processing methods discussed above with reference to FIGS. 2-11. In FIG. 12A, two consecutive pages within a document image are shown. The first page 1202 is referred to as page pₓ and the second page 1204 is referred to as page pₓ₊₁. The first page 1202 includes two text columns 1206-1207 and a two-column table 1208. The second page 1204 includes a last row 1210 of the two-column table, the bulk of which 1208 is included in the bottom of the first page 1202. As shown in FIG. 12B, it is likely that this last row of the two-column table 1210 will not be recognized as the last row of a table, but will instead be considered to either be a title 1212, as is the case in a first page hypothesis for page pₓ₊₁ 1214 or, alternatively, may simply be considered as part of the two text columns 1216-1217 in the page 1204, as in the second page hypothesis 1220 shown in FIG. 12B. Similarly, in FIG. 12C, two consecutive pages 1230 and 1232 are again shown, using similar illustration conventions as used in FIG. 12A. In this case, however, a first row of the two-column table 1234 appears at the bottom of the first page 1230 and the bulk of the two-column table 1236 appears at the top of the second page 1232. In this case, as shown in FIG. 12D, the first row of the two-column table 1234 may be interpreted as a footnote 1238, in the first page hypothesis 1240 shown in FIG. 12D, or may instead be interpreted as final portions of two text columns 1242-1243 in a second page hypothesis 1244 in FIG. 12D. There are many examples in which relatively small portions of logical page objects split over multiple pages or divisions between different types of page objects that occur near the beginning or end of a page result in selection of an incorrect page hypothesis for the page.

The deficiency illustrated in FIGS. 12A-D arises because, in the previously discussed image-processing methodologies, a best page hypothesis is selected for each page by considering only the page objects in the page with respect to each possible page hypothesis for the page, as discussed above with reference to FIG. 7. In the previously discussed image-processing methods, there is no attempt to evaluate page objects within a page with respect to page hypotheses for the page as well as page hypotheses already selected for the previous and following pages, if any, within the document. In the case shown in FIG. 12A, for example, when page object 1210 is evaluated with respect to page hypothesis for page pₓ, page object 1210 is likely to be recognized as the final row of two-column table 1208 rather than part of page objects 1216 and 1217 or an independent page object.

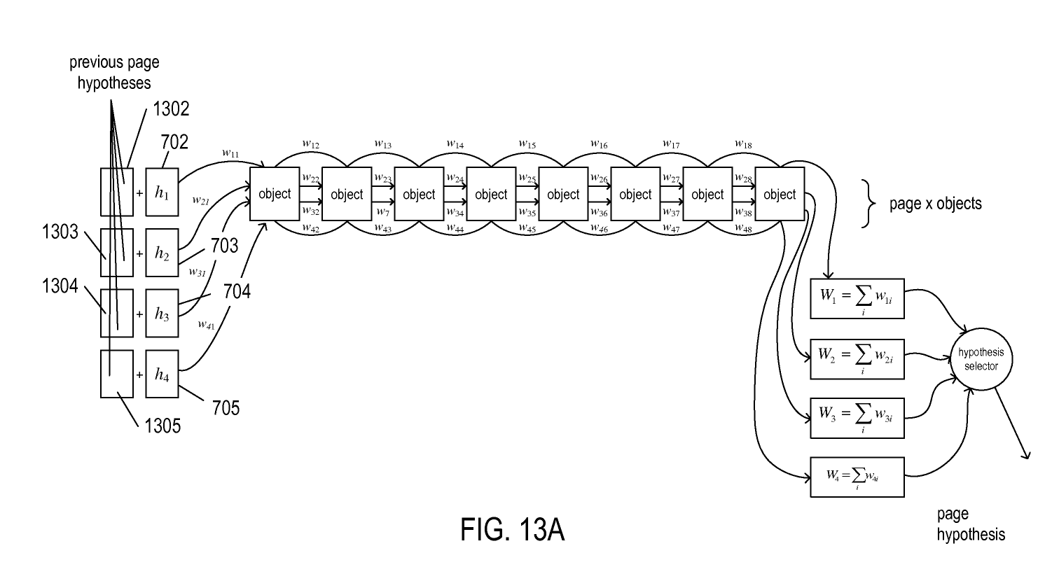

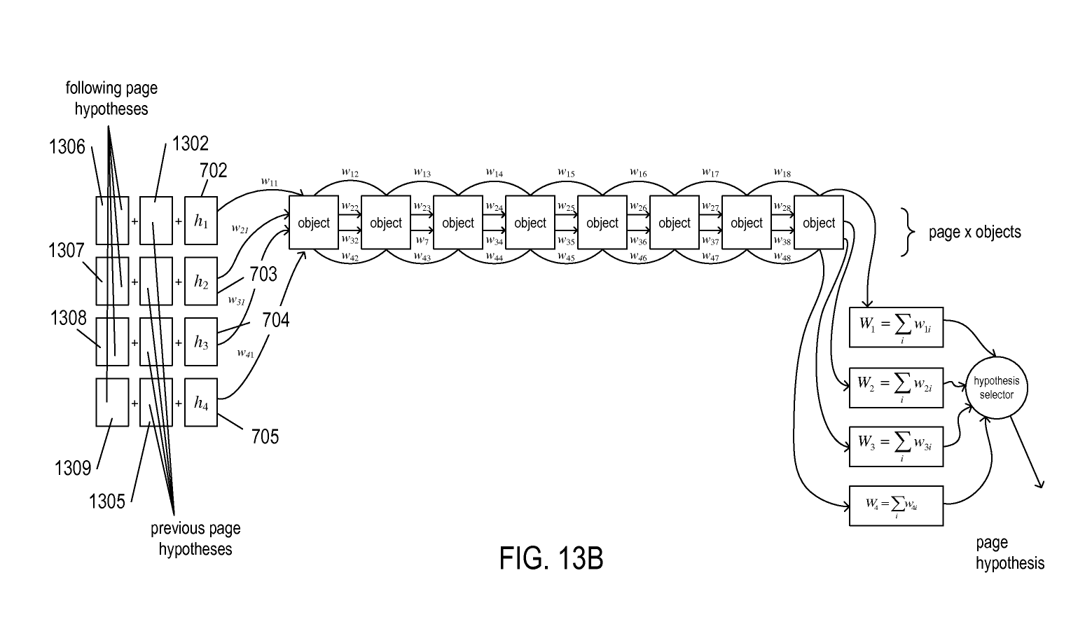

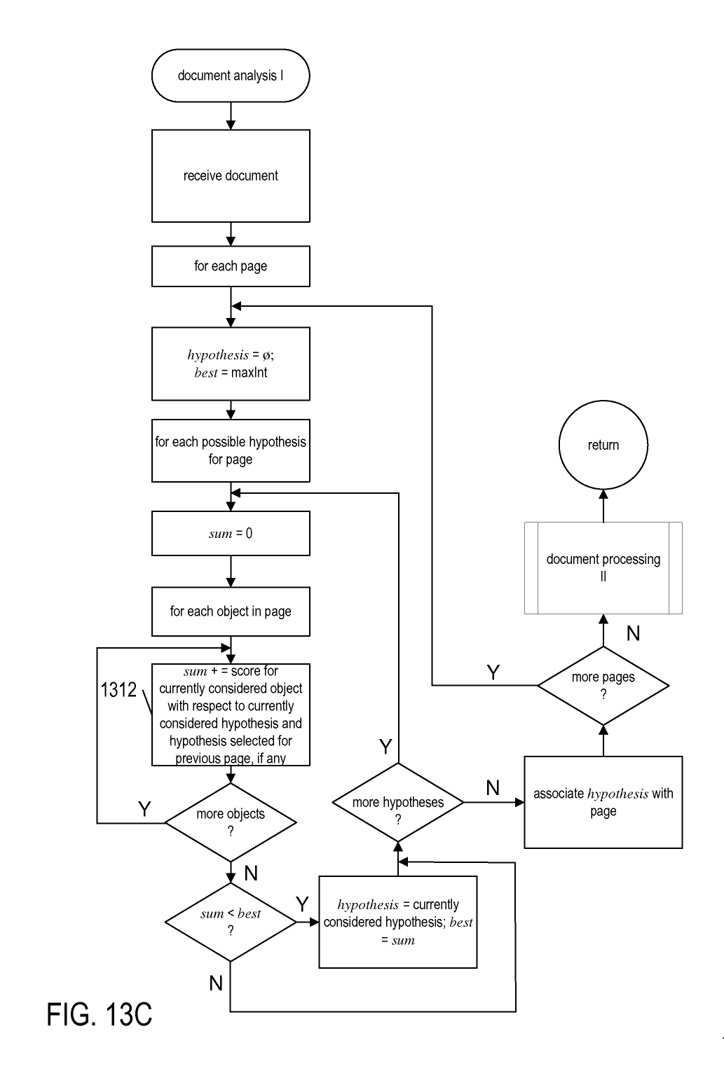

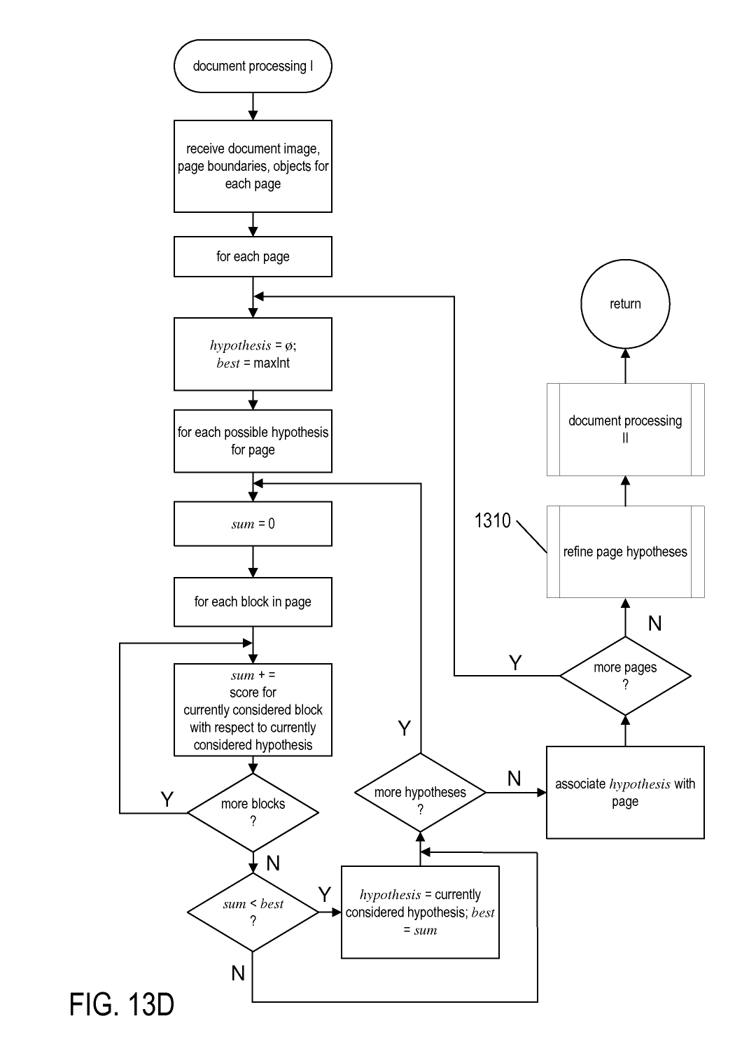

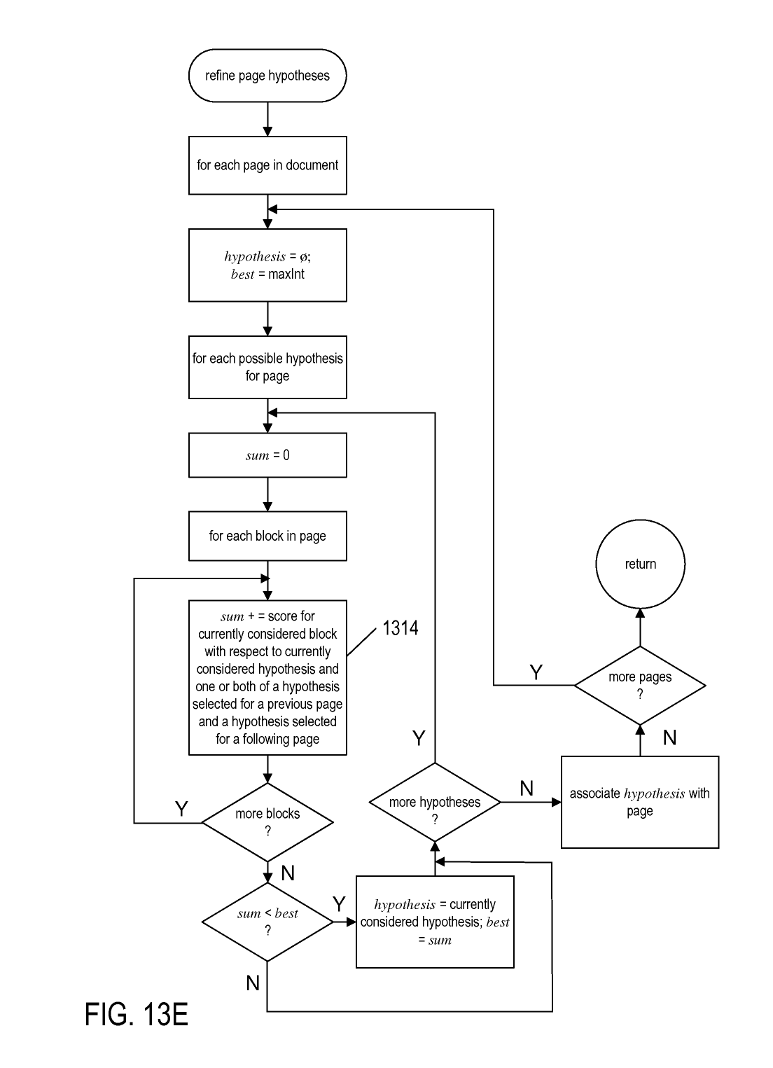

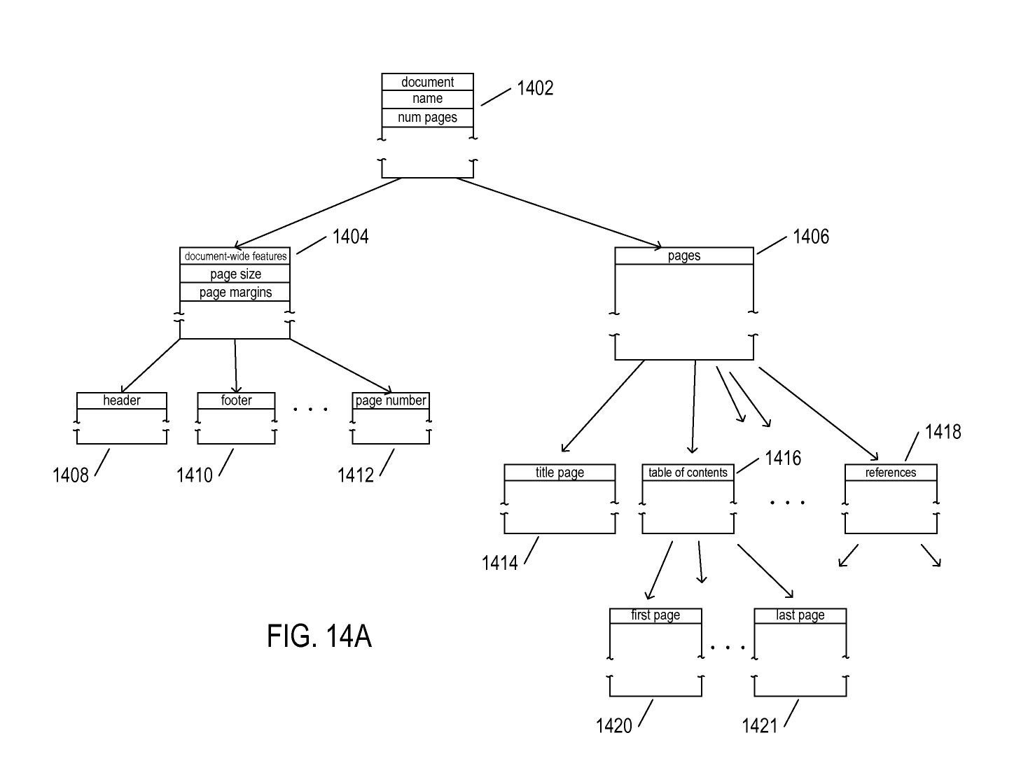

FIGS. 13A-E illustrate a context-based approach, using illustration conventions previously used in FIG. 7, that ameliorate the deficiencies discussed above with reference to FIGS. 12A-D. As shown in FIG. 13A, when evaluating a page hypothesis with respect to the objects within the page, the weight, or figure of merit, computed for each object with respect to a currently considered page hypothesis is based not only on the currently considered page hypothesis for the page containing the objects but also on the page hypothesis selected for a previous page in the document, when such a page exists. FIG. 13A is similar to FIG. 7, with the exception that the selected page hypothesis for the previous page 1302-1305 is used along with each individual hypothesis for a current page to compute the weight for the page hypothesis for a page. FIG. 13B illustrates a similar context-based approach to that shown in FIG. 13A in which both the page hypothesis selected for a page preceding the currently considered page 1302-1305 and the page hypothesis selected for a page following the currently considered page 1306-1309 are used along with the page hypothesis for the currently considered page when computing the weight, or figure of merit, computed for each object with respect to a currently considered page hypothesis. In this case, the weights computed for the page object 1210 will include comparisons of the page object with hypotheses for the currently considered page as well as the previous page. When the page object is interpreted as a final row of the a table, the weight will be significantly lower due to a low weight contributed by the previous page hypothesis.

FIG. 13C shows an implementation of the routine “document processing I,” an initial implementation for which is shown in FIG. 10 and discussed above, which includes consideration of the page hypothesis selected for a previous page, if any, when computing the weights for hypotheses being evaluated for a subsequent page. Only step 1312, similar to step 1009 in FIG. 10, of the steps in the implementation shown in FIG. 13C differs from a corresponding step in the implementation shown in FIG. 10. In this case, the score computed for a currently considered object with respect to the currently considered page hypothesis also includes consideration of the object with respect to the hypothesis selected for the previous page, when a previous page exists within the document image. FIG. 13D provides a control-flow diagram for a different implementation, in which the initial selection of page hypotheses is carried out in similar fashion to the implementation shown in FIG. 10, but in which an additional refinement step is included. In FIG. 13D, once the pages of a document have been associated with best page hypotheses, the routine “refine page hypotheses” is called, in step 1310, in order to refine the initial hypotheses. FIG. 13E provides a control-flow diagram for the routine “refine page hypotheses” called in step 1310 of FIG. 13D. The routine “refine page hypotheses” includes much of the same logic as used in FIGS. 10, 13C, and 13D. However, in step 1314, similar to step 1312 in FIG. 13C and step 1009 in FIG. 10, a score computed for each object in a page is computed with respect to the currently considered hypothesis and one or both of the hypotheses selected for the previous page and following page in the document image, when such pages exist.

Thus, a number of different approaches to ameliorating the deficiencies discussed above with reference to FIGS. 12A-D can be taken. In a first and second approach, only a single pass of page-hypothesis selection is carried out in the pages of a document. However, in this single pass, the weights computed for each page object are based on comparing each page object to the page hypothesis for the currently considered page as well as to a page hypothesis selected for a previous page, when such a previous page exists, or for page hypotheses selected for a previous page and a following page, when previous and following pages exist, as illustrated in FIGS. 13A-B. In a third approach, once all of the pages have been associated with page hypotheses as in the approach discussed with reference to FIG. 10, a second, refinement pass is undertaken to again compute the best page hypothesis for each page in the document image, but this time considering compatibility of each object in each page not only with a page hypothesis for that page, but also for the page hypotheses selected for one or both of the previous page and following page in the document image, when such pages exist in the document image.

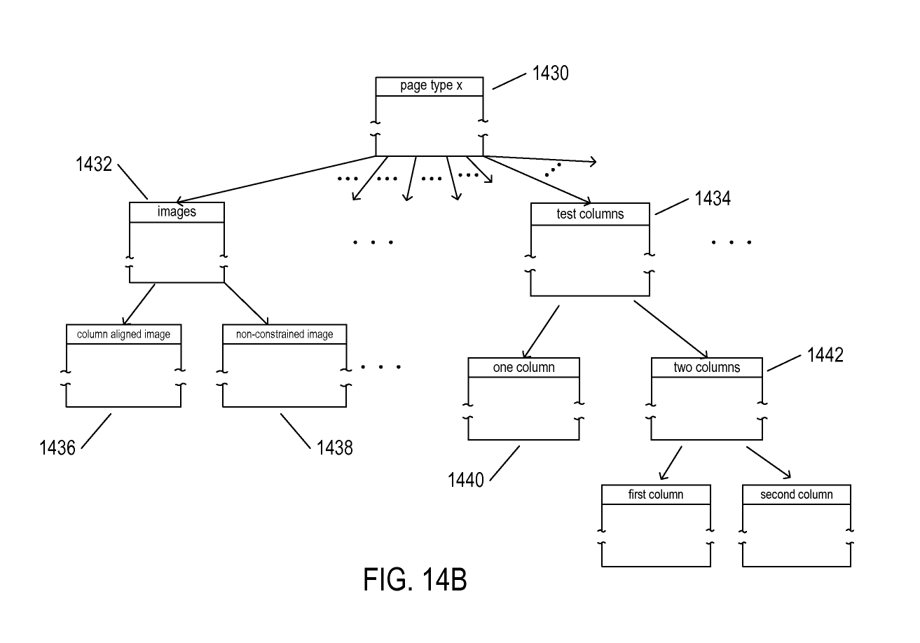

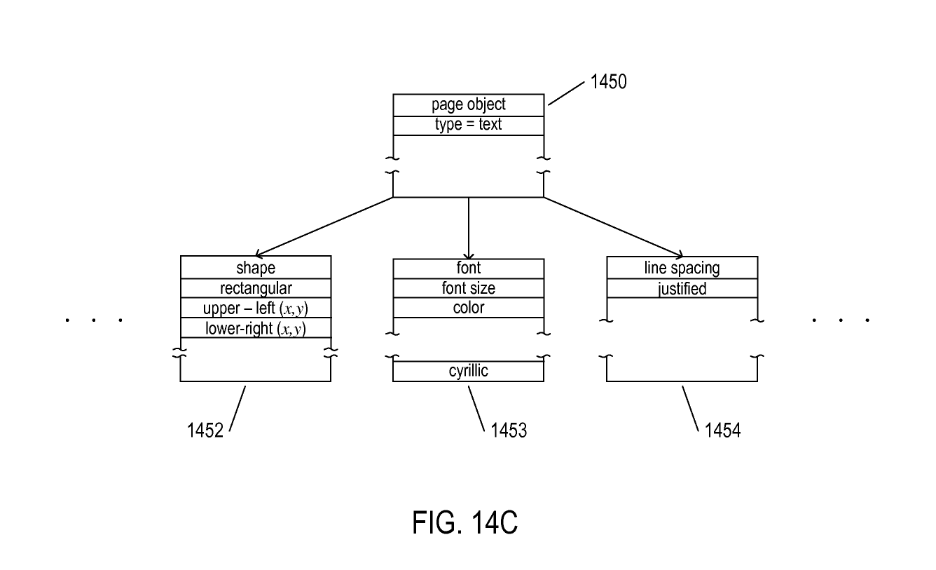

FIGS. 14A-C illustrate the nature of document and page hypotheses and page-related data structures. FIG. 14A illustrates the nature of a document hypothesis. The document hypothesis is hierarchical in nature, just as documents are hierarchical in nature, as discussed in previous sections and in the current subsection with reference to FIG. 2. The document may be represented by a document node, or root node for the document 1402, which includes various different types of parameters and associated values for the document as a whole. These may include the name of the document, the number of pages in the document, document type, and many other such parameter values. The root node 1402 may have numerous child nodes. In the example shown in FIG. 14A, the root node 1402 has a first child node 1404 that represents specific document-wide features and a second child node 1406 that represents the pages within the document. Document-wide features may include the common size of the pages in the document, page margins, various document-wide formatting, and other such features. The document-wide-features node 1404 may additionally include child nodes for various subcomponents of all of the pages of the document, such as headers 1408, footers 1410, and page numbers 1412. The pages node 1406 may have various child nodes that represents sets of one or more pages. In the example shown in FIG. 14A, the pages node 1406 has child nodes that represent a title page 1414, a set of table-of-contents pages 1416, other pages in the document, and a set of reference-containing pages 1418 at the end of the document. Each of these second-level nodes may have additional nodes. In the example shown in FIG. 14A, the table-of-contents-pages node 1416 has child nodes for each table-of-content page 1420-1421. The nodes representing pages may be the root nodes of subtrees corresponding to page hypotheses.

FIG. 14B illustrates a page hypothesis. A page hypothesis may have a root node 1430 that includes a page type and other parameter values. Each of the different types of structures within the page may be represented by child nodes. In the example shown in FIG. 14B, the page includes images, represented by images node 1432 and text columns represented by text-column node 1434. Each of these second-level nodes may also have child nodes. For example, the images node 1432 has children nodes for column-aligned images 1436 and non-constrained images 1438 that can appear anywhere on the page. Similarly, the text-columns node 1434 has children nodes for one-column columns that span the entire page 1440 and two-column columns that extend vertically, in parallel, down a page 1442. For all of the nodes shown in FIGS. 14A-B, there may be many different values for many different parameters. The parameter values contained in any particular node, the types of nodes and hierarchical structures that represent document hypotheses and page hypotheses may all vary considerably from one implementation to another.

FIG. 14C illustrates a logical-page-object data structure. The logical-page-object data structure is also hierarchical, including a root node 1450 with values for parameters that apply to the entire logical page object, such as an overall logical-object type. The root node may have child nodes, such as child nodes 1452-1454, which contain values for different, related sets of parameters. Node 1452 contains parameter values associated with the shape, size, and position of the logical object. Node 1453 contains values for a parameter that characterize the font, font size, and other aspects of the text contained in a text block. Node 1454 contains values for parameters associated with line spacing, justification of lines, and other such characteristics. There may be many additional types of parameters in these nodes as well as many additional nodes. Similar data structures are used for containing information about page objects.

While the document and page hypotheses, data structures, and the page-object data structure are hierarchical in nature they may, in various implementations, be contained within a single table or record or may be constructed and stored in a variety of alternative fashions. Again, many different variations in the data structures and encodings for document and page hypotheses and page-object data structures are possible.

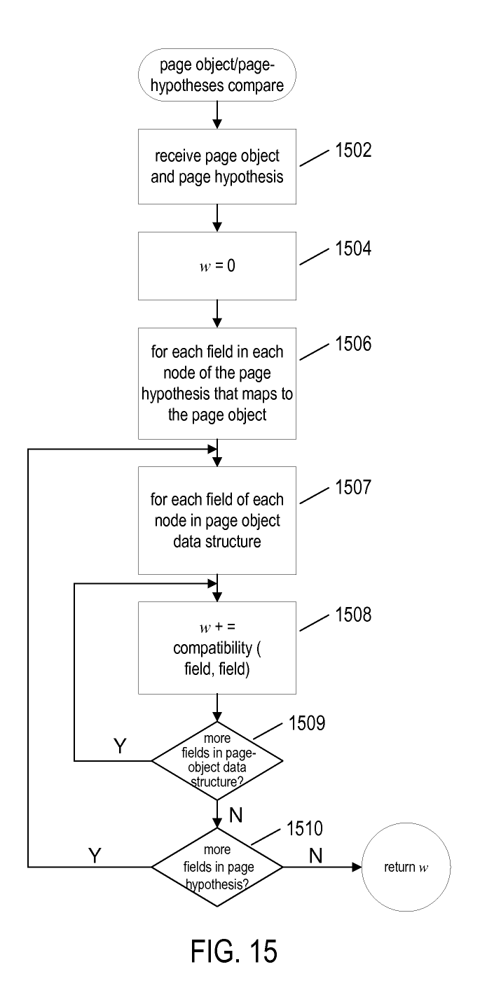

FIG. 15 provides a control-flow diagram for a routine that generates a weight for the comparison of a page object with one or more page hypotheses. In step 1502, the routine receives a page object and one or more page hypotheses. In step 1504, the local variable w is set to 0. Then, in the outer for-loop of steps 1506-1510, each field in each node of each page hypothesis that is relevant to the area of the page that contains the received object is considered. In the inner for-loop of steps 1507-1509, each field in each node of the page-object data structure for the page object is considered. In step 1508, a value that represents that compatibility of the currently considered field of the page-object data structure with the currently considered field of the one or more page hypotheses is added to the local variable w. Once the compatibilities for all fields in all nodes of the page-object data structure are compared to all fields of all page hypotheses in the nested for-loops of steps 1506-1510, the value stored in local variable w is returned. In many cases, node fields of the page-object data structure may not be comparable to a field within a node of a page hypothesis, in which case the compatibility function called in step 1508 returns 0. In alternative implementations, rather than computing a cross product of the fields in a page-object data structure with the fields in the received page hypotheses, a specific set of field-to-field comparisons is made.

Although the present invention has been described in terms of particular embodiments, it is not intended that the invention be limited to these embodiments. Modifications within the spirit of the invention will be apparent to those skilled in the art. For example, any of many different implementations of the context-based page-hypothesis-evaluation components of image-processing systems can be obtained by varying any of many different implementation and design parameters, including selection of programming language, operating system, underlying hardware platform, control structures, data structures, modular organization, and other such design and implementation parameters. Any of a wide variety of different types of hypothesis information can be used as well as many different types of comparison functions that compare page objects to hypotheses. In certain implementations, additional selected page hypotheses for additional, non-adjoining neighboring pages of a target page may be used for selecting a page hypotheses for the target page.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An document analysis system comprising:
one or more processors;
one or more memories; and
computer instructions, stored in one or more of the one or more memories that, when executed by one or more of the one or more processors, control the document analysis system to process an electronic document having two or more pages by
for each of two or more pages, determining a set of page hypotheses for the page,
for each of the two or more pages, selecting a page hypothesis for the page from the set of page hypotheses determined for the page based on a computed compatibility of the page hypothesis and one or more page hypotheses selected for one or more neighboring pages with page objects contained in the page,
using the page hypotheses selected for the two or more pages to select a document hypothesis for the document, and
storing an indication of the selected document hypothesis in one of the one or more memories.

2. The document analysis system of claim 1 wherein determining the set of page hypotheses for a page comprises one of:
selecting a set of stored page hypotheses;
selecting, from a set of stored page hypotheses, a subset of the stored page hypotheses compatible with one or more portions of the page; and
analyzing the page to identify objects within the page and constructing a set of hypotheses compatible with the identified objects.

3. The document analysis system of claim 1 wherein selecting a page hypothesis for the page based on a computed compatibility of the page hypothesis and one or more page hypotheses selected for one or more neighboring pages with page objects contained in the page further comprises:
for each page object contained in the page,
computing a compatibility of the page object with the page hypothesis and one or more page hypotheses each selected for one or more neighboring pages, and
adding the computed compatibility to a cumulative compatibility metric; and
selecting a page hypothesis from the set of page hypotheses with a cumulative compatibility metric that represents a highest cumulative compatibility for the page hypotheses in the set of page hypotheses.

4. The document analysis system of claim 3 wherein the compatibility metric computed for a page object with respect to the page hypothesis and one or more page hypotheses each selected for one or more neighboring pages includes a term for the compatibility of the page object with each structure and parameter value in the page hypothesis and one or more page hypotheses.

5. The document analysis system of claim 1 further comprising:
using the selected document hypothesis to refine an encoding of the document.

6. The document analysis system of claim 1 wherein using the page hypotheses selected for the two or more pages to select a document hypothesis for the document further comprises:
for each document hypothesis in a set of document hypotheses,
computing a cumulative compatibility metric for the document hypothesis with respect to the page hypotheses selected for the pages; and
selecting a document hypothesis from the set of document hypotheses with a computed cumulative compatibility metric that represents a highest computed compatibility for the document hypotheses in the set of document hypotheses.

7. The document analysis system of claim 6 wherein the set of document hypotheses is selected by one of:
selecting a set of stored document hypotheses; and
selecting, from a set of stored document hypotheses, a subset of the stored document hypotheses compatible with one or more portions of the pages.

8. The document analysis system of claim 6 wherein computing a compatibility of the document hypothesis with the page hypotheses selected for the pages further comprises:
for each page hypothesis selected for a page,
computing a compatibility metric for the document hypothesis with respect to the page hypothesis, and
adding the computed compatibility metric to the cumulative compatibility metric for the document hypothesis.

9. The document analysis system of claim 1
wherein a page hypothesis is a data structure that includes parameter values that specify the characteristics of, and structures within, a page of the type represented by the page hypothesis; and
wherein a document hypothesis is a data structure that includes parameter values that specify the characteristics of, and pages within, a document of the type represented by the document hypothesis.

10. A method, carried out within a document analysis system that includes one or more processors and one or more memories and implemented as computer instructions stored in one or more of the one or more memories that are executed by one or more of the one or more processors, that analyzes a document, the method comprising:
for each of two or more pages of the document, determining a set of page hypotheses for the page,
for each of the two or more pages, selecting a page hypothesis for the page from the set of page hypotheses determined for the page based on a computed compatibility of the page hypothesis and one or more page hypotheses selected for one or more neighboring pages with page objects contained in the page,
using the page hypotheses selected for the two or more pages to select a document hypothesis for the document, and
storing an indication of the selected document hypothesis in one of the one or more memories.

11. The method of claim 10 wherein determining the set of page hypotheses for a page comprises one of:
selecting a set of stored page hypotheses;
selecting, from a set of stored page hypotheses, a subset of the stored page hypotheses compatible with one or more portions of the page; and
analyzing the page to identify objects within the page and constructing a set of hypotheses compatible with the identified objects.

12. The method of claim 10 wherein selecting a page hypothesis for the page based on a computed compatibility of the page hypothesis and one or more page hypotheses selected for one or more neighboring pages with page objects contained in the page further comprises:
for each page object contained in the page,
computing a compatibility of the page object with the page hypothesis and one or more page hypotheses each selected for one or more neighboring pages, and
adding the computed compatibility to a cumulative compatibility metric; and
selecting a page hypothesis from the set of page hypotheses with a cumulative compatibility metric that represents a highest cumulative compatibility for the page hypotheses in the set of page hypotheses.

13. The method of claim 12 wherein the compatibility metric computed for a page object with respect to the page hypothesis and one or more page hypotheses each selected for one or more neighboring pages includes a term for the compatibility of the page object with each structure and parameter value in the page hypothesis and one or more page hypotheses.

14. The method of claim 10 further comprising:
using the selected document hypothesis to refine an encoding of the document.

15. The method of claim 10 wherein using the page hypotheses selected for the two or more pages to select a document hypothesis for the document further comprises:
for each document hypothesis in a set of document hypotheses,
computing a cumulative compatibility metric for the document hypothesis with respect to the page hypotheses selected for the pages; and
selecting a document hypothesis from the set of document hypotheses with a computed cumulative compatibility metric that represents a highest computed compatibility for the document hypotheses in the set of document hypotheses.

16. The method of claim 15 wherein the set of document hypotheses is selected by one of:
selecting a set of stored document hypotheses; and
selecting, from a set of stored document hypotheses, a subset of the stored document hypotheses compatible with one or more portions of the pages.

17. The method of claim 15 wherein computing a compatibility of the document hypothesis with the page hypotheses selected for the pages further comprises:
for each page hypothesis selected for a page,
computing a compatibility metric for the document hypothesis with respect to the page hypothesis, and
adding the computed compatibility metric to the cumulative compatibility metric for the document hypothesis.

18. The method of claim 10
wherein a page hypothesis is a data structure that includes parameter values that specify the characteristics of, and structures within, a page of the type represented by the page hypothesis; and
wherein a document hypothesis is a data structure that includes parameter values that specify the characteristics of, and pages within, a document of the type represented by the document hypothesis.

19. Computer instructions, stored in one or more memories of a document analysis system that additionally includes one or more processors that, when executed by one or more of the one or more processors, control the optical-symbol-recognition system to process a document image by:
for each of two or more pages of the document, determining a set of page hypotheses for the page,
for each of the two or more pages, selecting a page hypothesis for the page from the set of page hypotheses determined for the page based on a computed compatibility of the page hypothesis and one or more page hypotheses selected for one or more neighboring pages with page objects contained in the page,
using the page hypotheses selected for the two or more pages to select a document hypothesis for the document, and
storing an indication of the selected document hypothesis in one of the one or more memories.

20. The computer instructions of claim 19 wherein selecting a page hypothesis for the page based on a computed compatibility of the page hypothesis and one or more page hypotheses selected for one or more neighboring pages with page objects contained in the page further comprises:
for each page object contained in the page,
computing a compatibility of the page object with the page hypothesis and one or more page hypotheses each selected for one or more neighboring pages, and
adding the computed compatibility to a cumulative compatibility metric; and
selecting a page hypothesis from the set of page hypotheses with a cumulative compatibility metric that represents a highest cumulative compatibility for the page hypotheses in the set of page hypotheses.
